(19) United States
(12) Patent Application Publication
(10) Pub. No.: US 2026/0302695 A1
(43) Pub. Date: Oct. 1, 2026

(54) ELECTRICAL CONNECTOR WITH IMPROVED GROUNDING MEMBERS

(71) Applicant: FOXCONN INTEROCNNECT TECHNOLOGY LIMITED, Grand Cayman (KY)

(72) Inventors: MING-CHING CHEN, New Taipei (TW); Hung-chi Yu, New Taipei (TW)

(21) Appl. No.: 19/632,964

(22) Filed: Mar. 30, 2026

(30) Foreign Application Priority Data
Mar. 31, 2025 (CN) 202510397059.7
Mar. 31, 2025 (CN) 202510397270.9

(51) Int. Cl. H01R 13/6588; H01R 13/436; H01R 13/50; H01R 13/6471; H01R 13/6597

(52) U.S. Cl. CPC H01R 13/6588; H01R 13/4368; H01R 13/50; H01R 13/6471; H01R 13/6597

(57) ABSTRACT

An electrical connector includes: an insulating housing comprising a mating slot located between the sidewalls; at least one terminal module fixed to the housing and including an insulator, and a row of terminals fixed to the insulator, the row of terminals including plural pairs of signal terminals and plural ground terminals, each including a fixing portion fixed to the insulator, an elastic arm extending upwardly and obliquely from the fixing portion, and a leg portion extending from a lower end of the fixing portion, the elastic arm having a contacting portion extending into the mating slot; and a first grounding member fixed to the insulator and made of a conductive lossy material, the first grounding member contacting the ground terminals; wherein the first grounding member is located at an outside of the row of terminals and has plural vertical ribs aligned with the elastic arms of the ground terminals.

### BACKGROUND OF THE INVENTION

### 1. Field of the Invention

The present invention relates to an electrical connector with improved grounding members.

### 2. Description of Related Arts

Computer motherboards are equipped with electrical connectors, which can be used for the insertion of board cards such as graphics cards and memory modules to expand the functions of the computer. The electrical connector includes an insulating housing and two rows of terminal assemblies disposed in the insulating housing. The two terminal assemblies are arranged opposite each other, and each terminal assembly has a plurality of signal terminals and a plurality of ground terminals. However, there may be signal crosstalk between different terminals, which affects the stability of high-frequency signal transmission.

U.S. Pat. No. 11,870,171 discloses an electrical connector, which at least includes two signal terminal including two longer signal contacts and two shorter signal contacts, and two ground terminals. The two signal terminals are located between two adjacent ground terminals. In some embodiments, the two signal terminals and the two ground terminals are between two shields, with the two adjacent ground terminals contacting the two shields. In some embodiments, lossy elements shaped as strips are added to be electrically coupled to the ground terminals.

An improved electrical connector is desired.

### SUMMARY OF THE INVENTION

An object of the present invention is to provide an electrical connector with grounding members.

To achieve the above-mentioned object, an electrical connector comprises: an insulating housing comprising two opposing sidewalls and a mating slot located between the sidewalls; at least one terminal module fixed to the insulating housing and comprising an insulator, and a row of terminals fixed to the insulator and arranged in a first direction, the row of terminals comprising plural pairs of signal terminals and plural ground terminals respectively disposed at opposite sides of each pair of signal terminals, each of the terminals comprising a fixing portion fixed to the insulator, an elastic arm extending upwardly and obliquely from the fixing portion, and a leg portion extending from a lower end of the fixing portion, the elastic arm having a contacting portion extending into the mating slot; and a first grounding member fixed to the insulator and made of a conductive lossy material, the first grounding member contacting with the ground terminals; wherein the first grounding member is located at an outside of the row of terminals and has a plurality of vertical ribs, the vertical ribs are aligned with the elastic arms of the ground terminals one by one viewed in a second direction perpendicular to the sidewalls.

Other advantages and novel features of the invention will become more apparent from the following detailed description of the present embodiment when taken in conjunction with the accompanying drawings.

### BRIEF DESCRIPTION OF DRAWINGS

FIG. 1 is a perspective view of an electrical connector of a first embodiment of the present application;

FIG. 2 is an exploded perspective view of FIG. 1;

FIG. 3 is another exploded perspective view of FIG. 2;

FIG. 4 is a perspective view of a left half of a terminal module assembly in FIG. 3;

FIG. 5 is another perspective view of FIG. 4;

FIG. 6 is a perspective view of FIG. 5 with the insulator removed;

FIG. 7 is a front view of FIG. 6;

FIG. 8 is a rear view of FIG. 6;

FIG. 9 is a side view of FIG. 6;

FIG. 10 is a perspective view of the first grounding member;

FIG. 11 is an exploded perspective view of a right half of a terminal module assembly in FIG. 3;

FIG. 12 is a perspective view of a terminal module assembly in a second embodiment of the present application;

FIG. 13 is a perspective view of the terminal module assembly in FIG. 12 with the first grounding member and the insulator removed;

FIG. 14 is a perspective view of the terminals and the second grounding member in FIG. 12;

FIG. 15 is an exploded perspective view of FIG. 14;

FIG. 16 is a perspective view of an electrical connector of a third embodiment of the present application, showing only a partial structure of the electrical connector;

FIG. 17 is a cross-sectional view taken along line A-A of FIG. 16;

FIG. 18 is a perspective view of a terminal module assembly in FIG. 12;

FIG. 19 is another perspective view of FIG. 18;

FIG. 20 is a perspective view of FIG. 18 with the insulator removed;

FIG. 21 is an exploded perspective view of FIG. 19; and

FIG. 22 is a perspective view of the third grounding member.

### DETAILED DESCRIPTION OF THE PREFERRED EMBODIMENT

Reference will now be made to the drawing figures to describe a preferred embodiment of the present invention in detail.

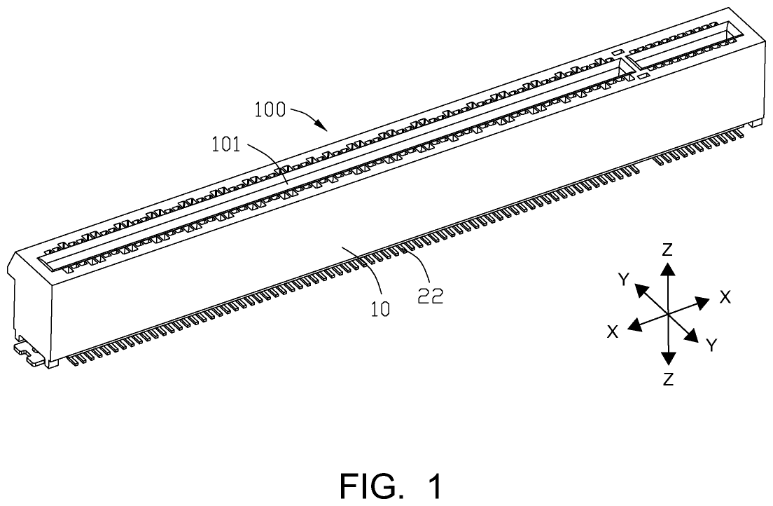

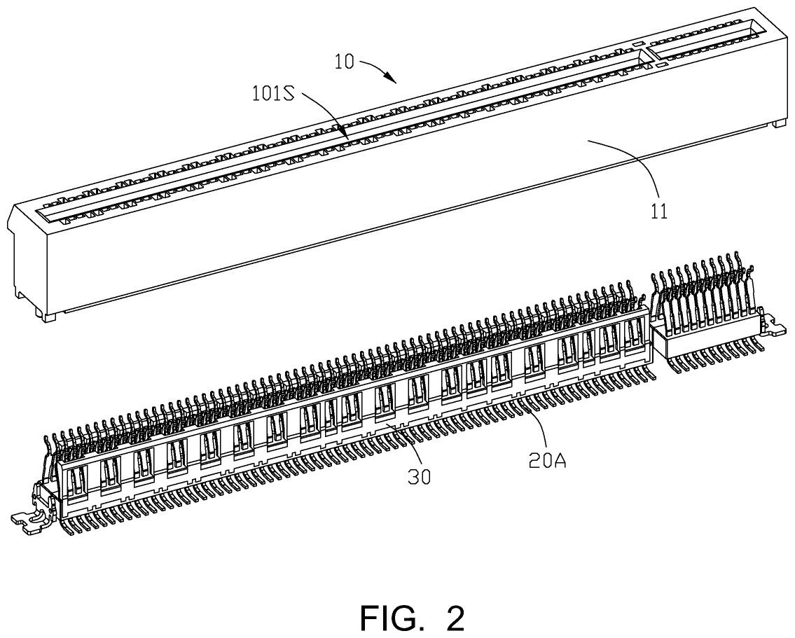

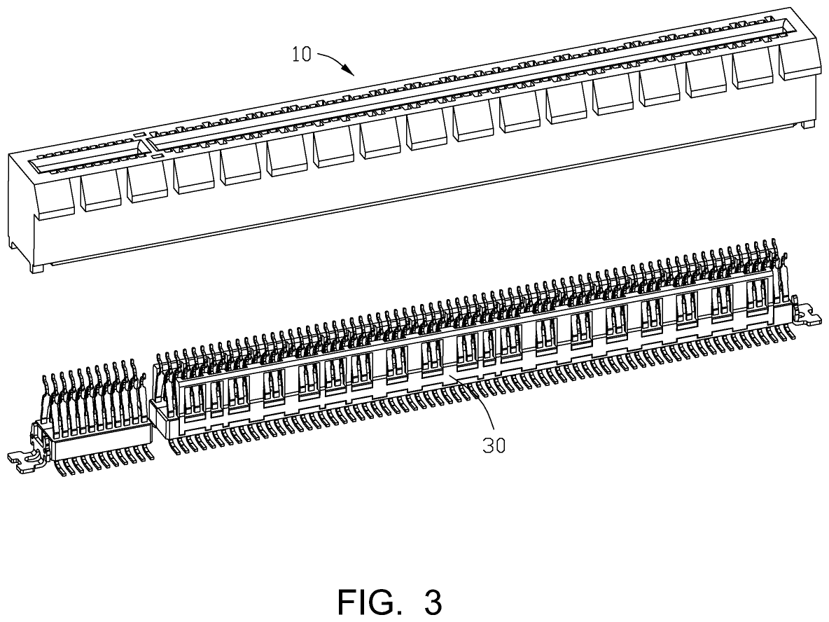

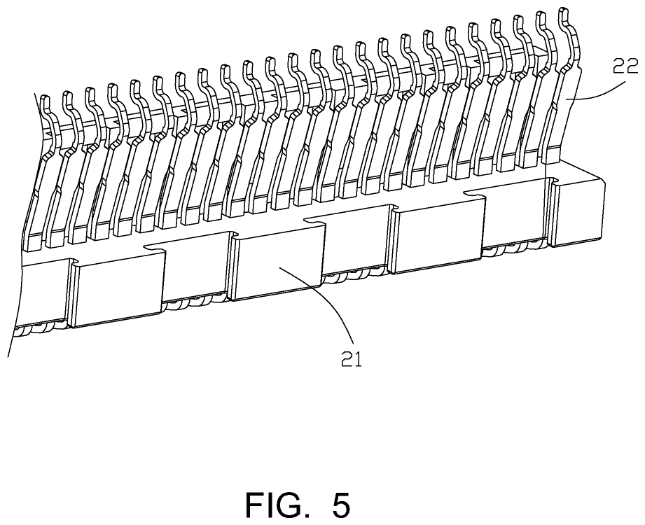

Electrical connectors of three embodiments are illustrated hereinafter, and the electrical connectors are a type of a card edge connector compliant with the PCIe CEM specification protocol. Referring to FIGS. 1-11 showing a first embodiment, the electrical connector 100 includes an insulating housing 10, at least one terminal module 20A, and a first grounding member 30. The insulating housing 10 has an elongated structure and includes two opposing sidewalls 11 and a mating slot 101 located between the sidewalls. The terminal module 20A is fixed to the insulating housing 10. Referring to FIG. 2, the electrical connector for receiving PCIe CEM board has a left mating slot and a right mating slot. The left mating slot is disposed with signal terminals for signal transmission and is referred to as the signal slot 101S. The right mating slot is located with power terminals and detection terminals, mainly for power transmission. In other embodiments, the electrical connector can be a card edge connector compliant with the SFF-TA-1002 specification protocol, which includes multiple signal slots. The improvement of this application is mainly applied to the signal slot 101S, aimed at high-frequency and high-speed signal transmission.

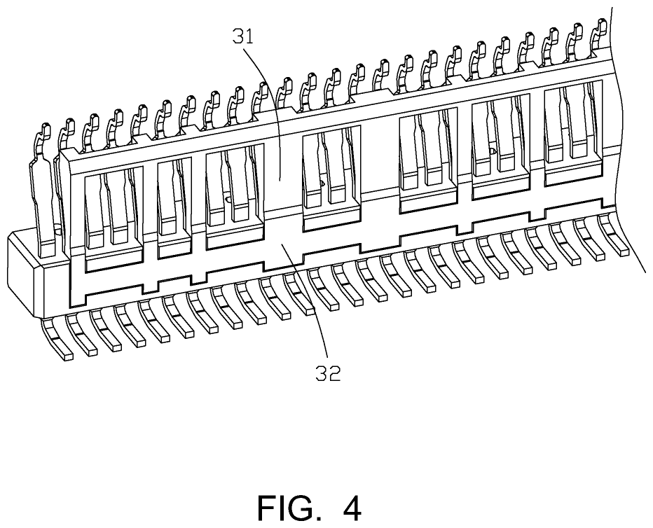

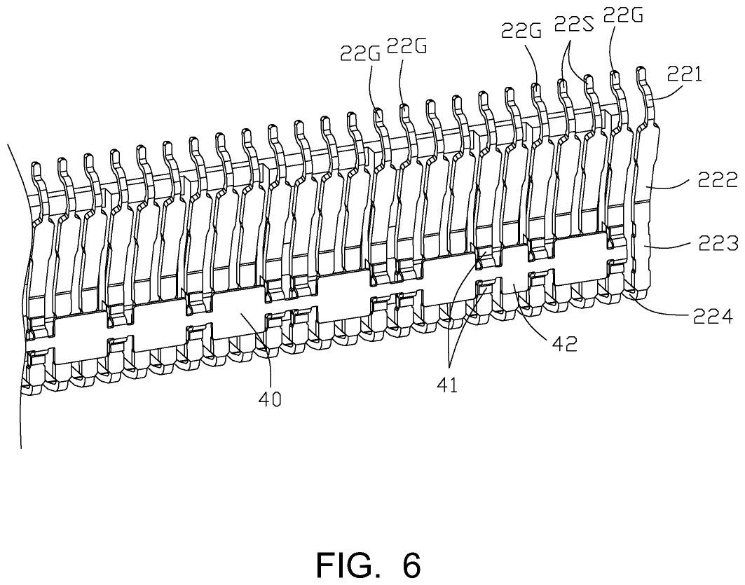

Referring to FIGS. 4-6, each terminal module 20A includes an insulator 21 and a row of terminals 22 fixed to the insulator. The row of terminals is arranged in a first direction X-X, i.e., the longitudinal direction and includes plural pairs of signal terminals 22S and plural ground terminals 22G. Each pair of signal terminals includes two adjacent signal terminals 22S, and the ground terminals 22G are disposed on opposite sides of each pair of signal terminals 22S. In this embodiment, some low-speed signal terminals are provided in the signal slot, such as the signal terminal closest to the right in FIG. 6, which is used for transmitting detection signals and the like. Such low-speed signals do not require special improvement for signal transmission. The first grounding member 30 is made of a conductive lossy material. The first grounding member 30 is fixed to the insulator 21 and is located on an outside of the row of terminals. The first grounding member 30 contacts the ground terminals 20G one by one. In the preferred embodiment, the conductive lossy material can be conductive plastic. For convenience of description, the side adjacent to the mating slot 101 is referred to the inside, and the opposite side is referred to the outside.

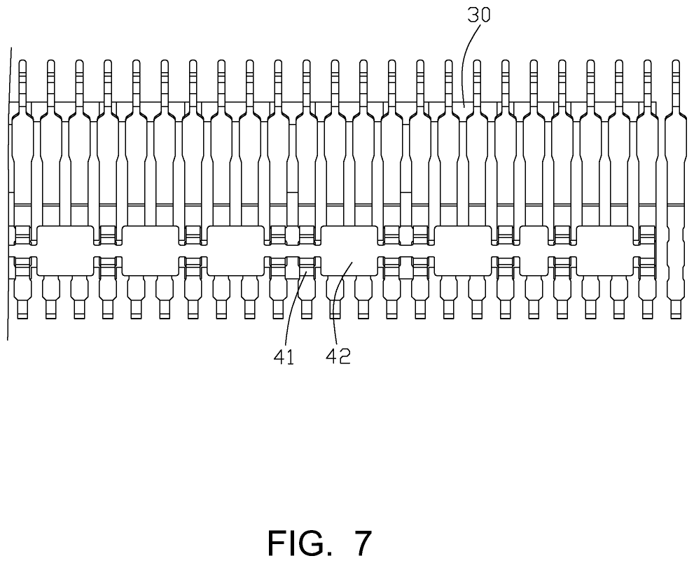

Each terminal 22 includes a fixing portion 223 fixed to the insulator 21, an elastic arm 222 extending upwardly and obliquely from the fixing portion 223, and a leg portion 224 extending from a lower end of the fixing portion. The elastic arm 222 has a contacting portion 221 extending into the mating slot 101. As shown in FIGS. 6-7, the width of the elastic arm 222 is greater than the width of the contacting portion 221 in the first direction X-X, and the width of the elastic arm 222 is greater than the width of the fixing portion 223 in the first direction X-X, thereby improving the mechanical structure of the terminals 22 and makes the terminals be suitable for high-frequency and high-speed signal transmission.

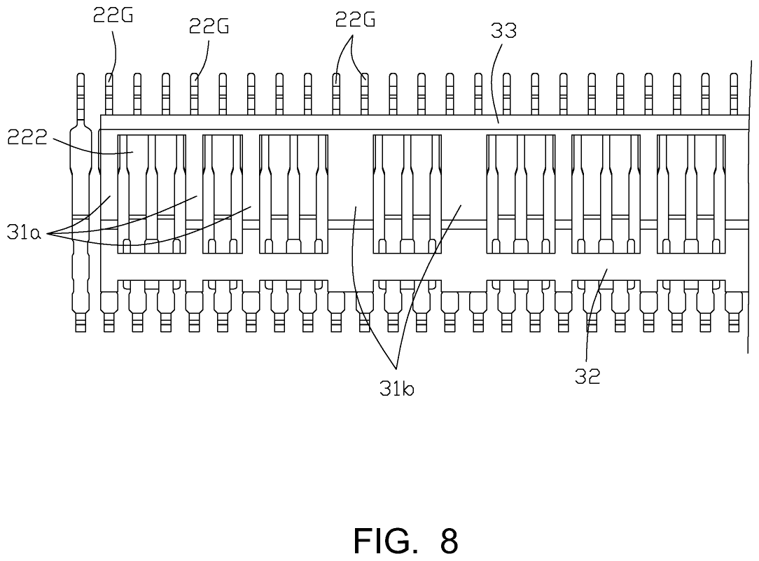

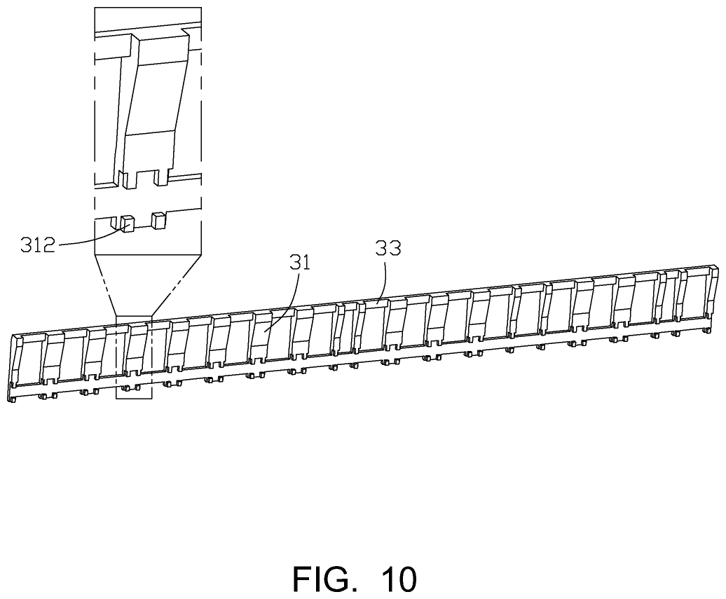

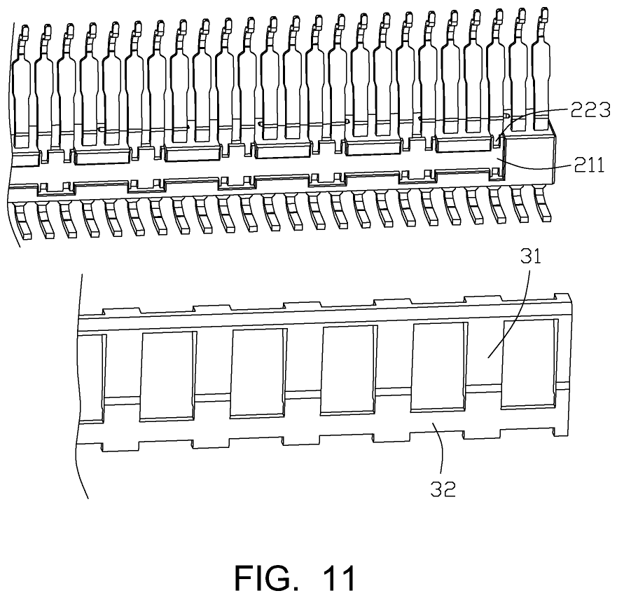

Referring to FIGS. 10-11, the first grounding member 30 includes a plurality of vertical ribs 31. Viewed from a second direction Y-Y perpendicular to the sidewall 11, i.e., the lateral direction as shown in FIG. 8, the vertical ribs 31 are aligned with the elastic arms 222 of the ground terminals 20G one by one. In this embodiment, there are two ground terminals 22G between some adjacent pairs of signal terminals, and only one ground terminal on one side of some pairs of signal terminal. Therefore, the vertical ribs 31 include narrow vertical ribs 31a and wide vertical ribs 31b with different widths in the first direction. The wide vertical rib 31b can simultaneously correspond to two ground terminals 22G. In this embodiment, the electrical connector 100 includes two terminal modules 20A in a mirror-image relationship. The two terminal modules 20A are respectively fixed to the opposing sidewalls 11 and are located on opposite sides of the mating slot 101. Each terminal module 20A has a first grounding member 30. More specifically, the first grounding member 30 has no vertical ribs corresponding to the signal terminal 22S.

More specifically, the insulator 21 has a retaining slot 211 corresponding to the ground terminal 20G. The fixing portion 223 of the ground terminal is partially exposed in the retaining slot 211, and a lower end of the vertical rib 31 is fixed in the retaining slot 211. The first grounding member 30 includes a lower bar 32 connecting adjacent vertical ribs 31, and the lower bar 32 is also fixed in the retaining slot 211. Thus, after the first grounding member 30 is assembled to the insulator 21, the first grounding member can abut against the portions of the fixing portions 223 exposed in the retaining slot 211.

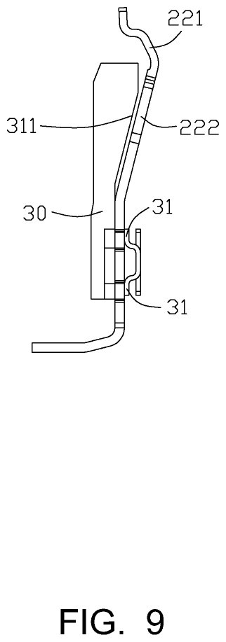

More specifically, as shown in FIG. 9, the outside of the vertical rib 31 is vertical, the lower part of the inside 311 of the vertical rib 31 is vertical, and the upper part of the inside 311 of the vertical rib 31 is inclined. The shape of the inside 311 of the vertical rib 31 is determined to match the shape of the ground terminal 22G, so that the inside 311 of the vertical rib 31 is spaced a certain distance from the elastic arm 222 of the terminal with a gap. It can be seen that the vertical rib 31 not only corresponds to the fixing portion 223 of the ground terminal, but also extends upward to the elastic arm 222, thereby changing the electric field of the electrical connector and achieve the purpose of improving electrical performance. In the preferred embodiment, the vertical rib 31 extends upward to a position close to the contacting portion 221, which can maximize the change in the electric field and achieve the best improvement in electrical performance.

The lower part of the vertical rib 31 contacts the fixing portion 223 of the ground terminal. In this embodiment, a plurality of abutment blocks 312 are formed on the inside of the vertical rib 31, and the abutment blocks 312 contact the fixing portions 223 of the corresponding ground terminals one by one. In other embodiments, the inside 311 of the vertical rib can directly press against the fixing portion 223.

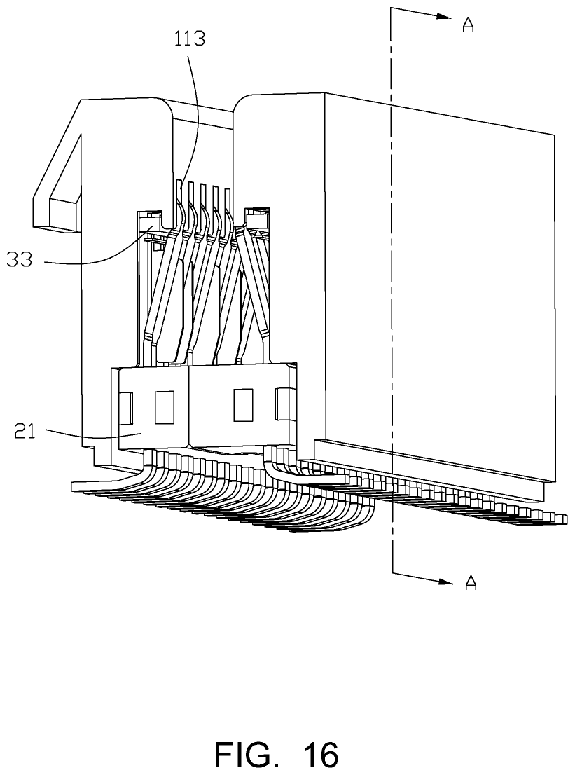

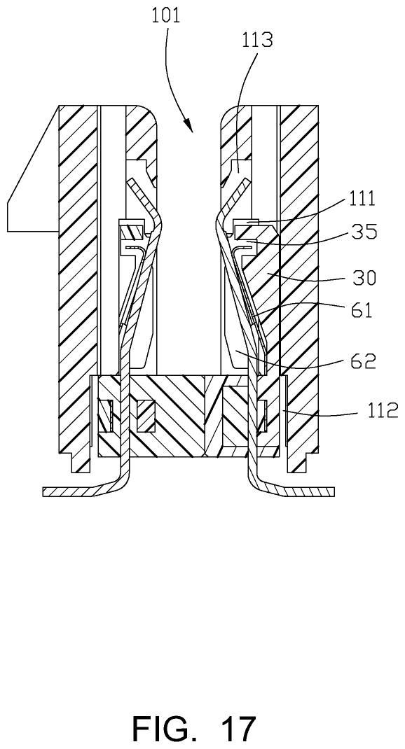

The first grounding member 30 includes an upper bar 33 connecting adjacent vertical ribs 31, and the upper bar 33 is located on the outside of the contacting portions 221 of the row of terminals. Referring to FIGS. 16-17 showing the structure of the insulating housing 10 in the third embodiment, the sidewall 11 of the insulating housing has a first fixing slot 111, a second fixing slot 112, and a plurality of terminal passages 113 spaced apart from each other in the first direction. The second fixing slot 112 is located immediately outside the terminal passage 113. The contacting portions 221 of the terminals are respectively received in the corresponding terminal passages 113, the insulator 21 is fixed in the first fixing slot 111, and the upper bar 33 is fixed in the second fixing slot 112.

Referring to FIGS. 6, 7, and 9, the electrical connector 100 includes a second grounding member 40. The second grounding member 40 is fixed to the insulator 21 and is located on the inside of the row of terminals. The second grounding member 40 contacts the ground terminals 20G one by one. In this embodiment, the second grounding member 40 is made of a metal conductive material and includes abutment tabs 41 abutting the corresponding ground terminals 22G. In this embodiment, the second grounding member 40 has two abutment tabs 41 in the up-down direction Z-Z. The abutment tabs 41 abut against the inner side of the fixing portion 223 of the ground terminal, forming two contact points. The second grounding member 40 has a shielding portion 42 between the adjacent abutment tabs 41. The shielding portion 42 corresponds to the pair of signal terminals 22S and is used to shield the pair of signal terminals from external electromagnetic interference. The shielding portion 42 is larger than the abutment tabs 41 in the up-down direction. The first and second grounding members respectively contact the outer and inner sides of the ground terminals 22G, thereby avoiding asymmetric coupling as much as possible and achieving the purpose of improving high-frequency and high-speed signal transmission performance.

During manufacturing, the insulating material is used to fix a row of terminals 22 by injection molding, and the cooled insulating material forms the insulator 21. The first grounding member 30 is assembled to the outside of the insulator 21 from the second direction Y-Y, and the second grounding member 40 is assembled to the inside of the insulator 21 from the second direction Y-Y. It can be seen that the first and second grounding members abut against the ground terminals 22G from two opposite directions in the second direction, thereby providing multiple grounding paths. At the same time, the inner and outer sides of the ground terminals are provided with grounding paths, achieving a common ground effect, which is referred to as common ground in the industry, increasing the resonance frequency of the electrical connector and meeting electrical performance requirements. After the terminal module 20A is combined with the first and second grounding members, a terminal module assembly is formed. After two terminal module assemblies are assembled together and then inserted into the insulating housing 10 together, thereby forming a complete electrical connector 100.

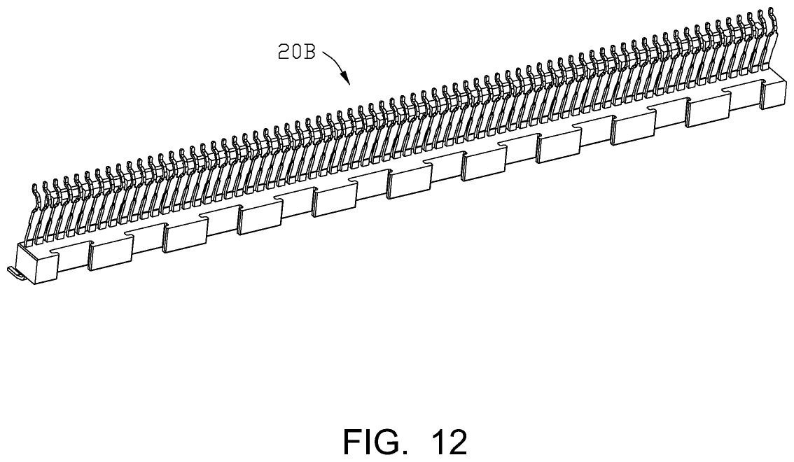

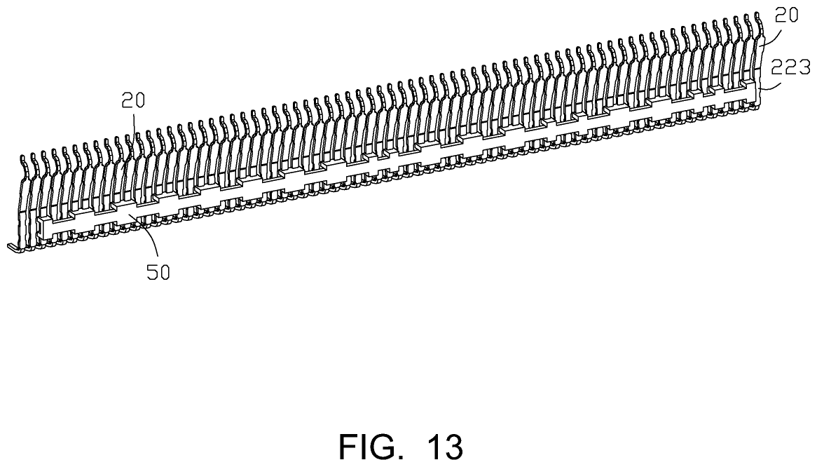

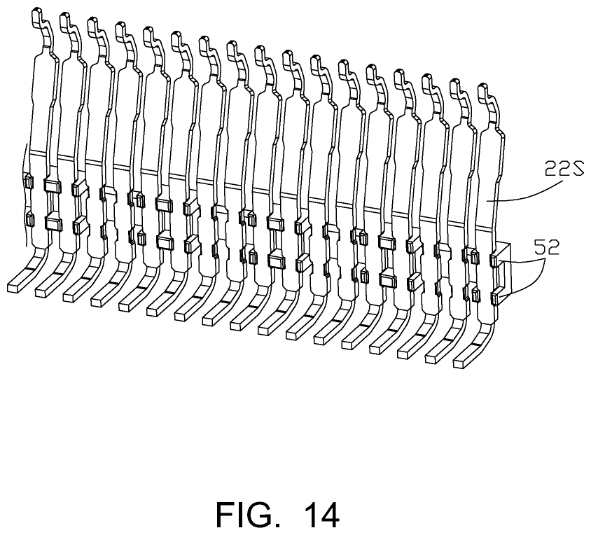

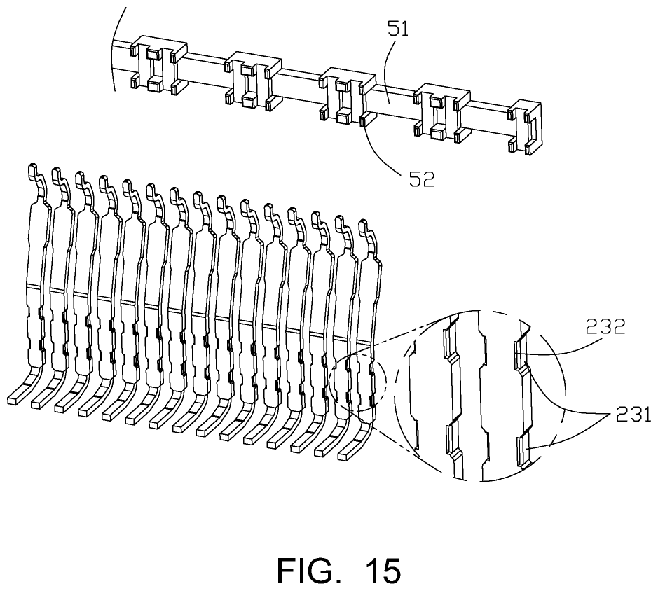

Referring to FIGS. 12-15 showing a second embodiment, the main improvement is focused on the second grounding member 50. Only one terminal module assembly 20B is shown in the drawings, and the same reference numerals are used for the same structures, which will not be described in detail again. The second grounding member 50 is made of a conductive lossy material. The second grounding member 50 is firstly assembled to a row of terminals 20, and then the insulating material is injection-molded on the outside of the second grounding member 50 and the row of terminals 20. The second grounding member 50 is completely embedded in the insulator 21. In a specific embodiment, notches 231 are formed on opposite sides of the fixing portion 223 of the ground terminal 22G in the first direction. The second grounding member 50 includes a longitudinal bar 51 and latches 52 protruding from the longitudinal bar 51. The latches 52 are positioned and fixed in the notches 231 one by one. Each notch has a recess 232 at a bottom thereof, and the latches of the second conductive member supported by conductive plastic can be further fixed in the notches 231 by hot-melt adhesive. The inner side of the fixing portion of the ground terminal is supported by the second grounding member 50.

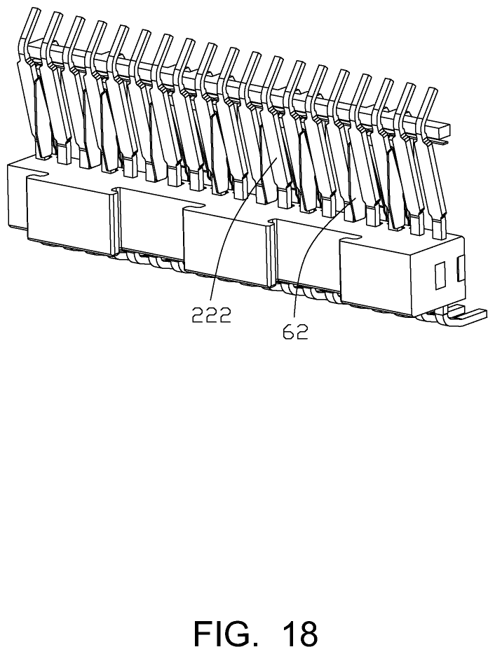

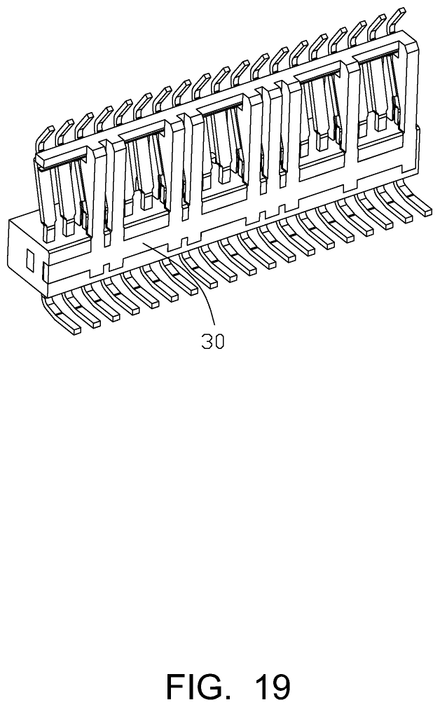

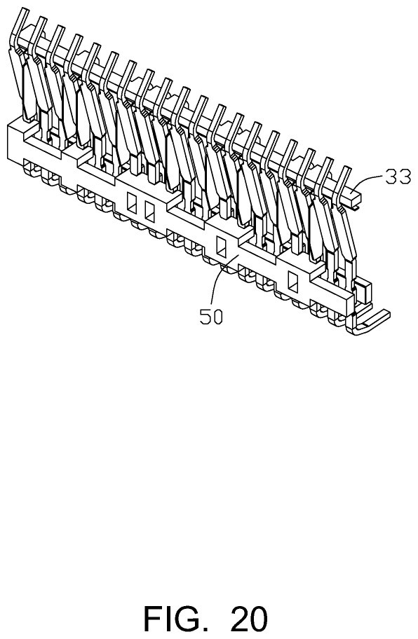

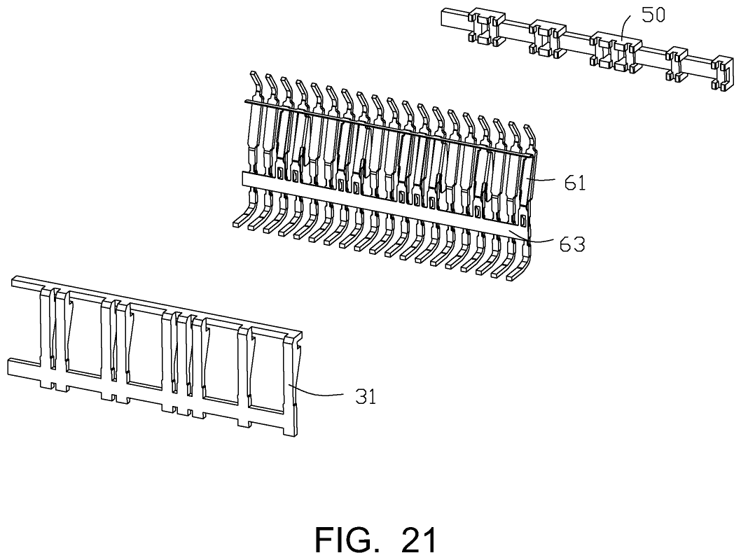

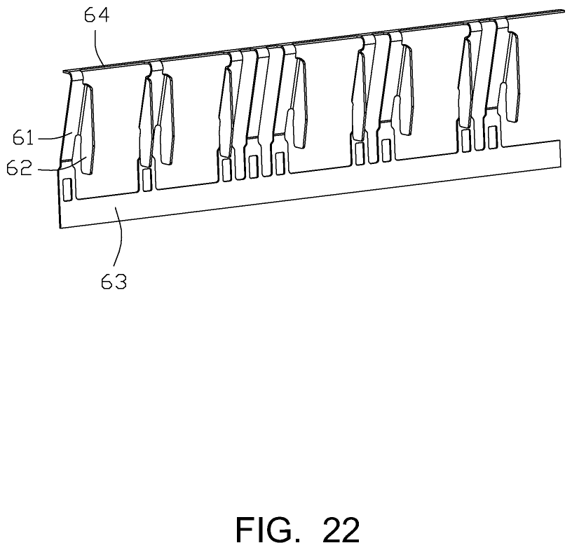

Referring to FIGS. 16-22 showing a third embodiment, a third grounding member 60 is added based on the second embodiment. The drawings only illustrate a partial structure of the electrical connector, and the same parts are not described in detail, only the differences are introduced. In this embodiment, the third grounding member 60 is fixed to the insulator 21 and is located between the outer side of the row of terminals 22 and the inside of the first grounding member 30. The third grounding member 60 is made of a metal conductive material. The third grounding member 60 includes plural first plate portions 61 and plural second plate portions 62. Viewed from the second direction Y-Y, the first plate portions 61 are aligned with the fixing portions 223 one by one and the elastic arms 222 of the ground terminals, serving to shield external noise. The second plate portions 62 bend from the first plate portions 61 and are located between adjacent ground terminals 22G and signal terminals 22S, serving to reduce mutual interference between adjacent pairs of signal terminals.

The lower ends of first plate portions 61 are integrally connected by a lower bar 63, and the lower bar 63 is fixed inside the insulator 21. The upper ends of the plurality of first plate portions are integrally connected by an upper bar 64, and the upper bar 64 bends outward. The upper bar 63 is just accommodated in the notch 35 provided in the first grounding member 30. As shown in FIG. 17, when the elastic arm 222 of the terminal is pushed to move outwards, the elastic arm 222 pushes the upper bar 64 of the third grounding member to move outward, and the notch 64 provides space for the upper bar to move outward.

The above-mentioned embodiments are only preferred embodiments of the present invention, and should not limit the scope of the present invention, any simple equivalent changes and modifications made according to the claims of the present invention and the contents of the description should still belong to the present invention.

1. An electrical connector comprising:
an insulating housing comprising two opposing sidewalls and a mating slot located between the sidewalls;
at least one terminal module fixed to the insulating housing and comprising an insulator and a row of terminals fixed to the insulator and arranged in a first direction, the row of terminals comprising plural pairs of signal terminals and plural ground terminals respectively disposed at opposite sides of each pair of signal terminals, each of the terminals comprising a fixing portion fixed to the insulator, an elastic arm extending upwardly and obliquely from the fixing portion, and a leg portion extending from a lower end of the fixing portion, the elastic arm having a contacting portion extending into the mating slot; and
a first grounding member fixed to the insulator and made of a conductive lossy material, the first grounding member contacting the ground terminals;
wherein the first grounding member is located at an outside of the row of terminals and has a plurality of vertical ribs, the vertical ribs are aligned with the elastic arms of the ground terminals one by one viewed in a second direction perpendicular to the sidewalls.

2. The electrical connector according to claim 1, wherein the first grounding member has no vertical ribs corresponding to the signal terminals.

3. The electrical connector according to claim 1, wherein the insulator has plural retaining slots, the fixing portions of the ground terminals are exposed to the retaining slots respectively, and a lower portion of the vertical rib is fixed in a corresponding retaining slot.

4. The electrical connector according to claim 3, wherein the first grounding member comprises a lower bar connecting adjacent vertical ribs, and the lower bar is fixed in the retaining slot.

5. The electrical connector according to claim 1, wherein the vertical ribs extend upward to proximately the contacting portions.

6. The electrical connector according to claim 1, wherein the vertical ribs are spaced away from the elastic arms of the grounding terminals respectively with a gap in the second direction.

7. The electrical connector according to claim 6, wherein the vertical rib has a plurality of abutment blocks contacting the fixing portion of a corresponding ground terminal.

8. The electrical connector according to claim 1, wherein the first grounding member comprises an upper bar connecting adjacent vertical ribs, and the upper bar is located at the outside of the contacting portions of the row of terminals.

9. The electrical connector according to claim 8, wherein the sidewall of the insulating housing has a first fixing slot and a second fixing slot extending in the first direction, and a plurality of terminal passages spaced apart from each other, the contacting portions of the terminals are respectively received in corresponding terminal passages, the insulator is fixed in the first fixing slot, and the upper bar is fixed in the second fixing slot.

10. The electrical connector according to claim 1, wherein the first grounding member is formed by injection molding of conductive plastic.

11. An electrical connector comprising:
an insulating housing comprising two opposing sidewalls and a mating slot located between the sidewalls;
two terminal modules fixed to the insulating housing, each terminal module including an insulator and a row of terminals fixed to the insulator and arranged in a first direction, the row of terminals comprising plural pairs of signal terminals and plural ground terminals respectively disposed at opposite sides of each pair of signal terminals, each terminal comprising a fixing portion fixed to the insulator, an elastic arm extending upwardly and obliquely from the fixing portion, and a leg portion extending from a lower end of the fixing portion, the elastic arm having a contacting portion extending into the mating slot;
a first grounding member fixed to the insulator and contacting the ground terminals; and
a second grounding member fixed to the insulator and contacting the ground terminals;
wherein the first grounding member is made of a conductive lossy material, and is located at an outside of the row of terminals, and the second grounding member is located at an inside of the row of terminals.

12. The electrical connector according to claim 11, wherein the first grounding member has plural vertical ribs aligned with the elastic arms of the ground terminals.

13. The electrical connector according to claim 11, wherein the second grounding member is made of a metal conductive material and has abutment tabs abutting the ground terminals.

14. The electrical connector according to claim 13, wherein the second grounding member has a shielding portion between adjacent abutment tabs, and the shielding portion is larger than the abutment tabs in an up-down direction.

15. The electrical connector according to claim 11, wherein the second grounding member is made of a conductive lossy material.

16. The electrical connector according to claim 11, further comprising a third grounding member, and wherein the third grounding member is fixed to the insulator and is located between the row of terminals and the first grounding member, the third grounding member comprises first plate portions and second plate portions, the first plate portions are aligned with the vertical ribs one by one, and the second plate portions bend from the first plate portions and are located between adjacent ground terminals and signal terminals.

17. The electrical connector according to claim 16, wherein the second grounding member is embedded in the insulator, the third grounding member is assembled to the insulator, and the first grounding member is assembled to the insulator.
